(19) United States
(12) Patent Application Publication
(10) Pub. No.: US 2004/0189099 A1
(43) Pub. Date: Sep. 30, 2004

(54) Shore power interface

(75) Inventor: Arthur Wild, Chillicothe, IL (US)

Correspondence Address: Finnegan, Henderson, Farabow,, Garrett & Dunner, L.L.P., 1300 I Street, N.W., Washington, DC, 20005-3315, US

(73) Assignee: Caterpillar Inc.

(21) Appl. No.: 10/742,996

(22) Filed: Dec. 23, 2003

Related U.S. Application Data
(60) Provisional application No. 60/458,460, filed on Mar. 28, 2003.

(51) Int. Cl. H02J 1/00

(52) U.S. Cl. 307/80

(57) ABSTRACT

A power circuit includes a first electrically-energizable contactor configured to receive a first power input of 110-120 volts of alternating current (VAC), and a second electrically-energizable contactor configured to receive a second power input of 220-240 VAC. The first and second contactors are arranged such that when one of the first and second contactors is energized by the corresponding power input, the energized one of the first and second contactors prevents the other one of the first and second contactors from being energized.

### CROSS-REFERENCE TO RELATED APPLICATION

This application claims the benefit of provisional patent application No. 60/458,460, filed on Mar. 28, 2003, the contents of which are incorporated herein by reference.

### TECHNICAL FIELD

The present invention is directed to a shore power interface. More particularly, the present invention is directed to a shore power interface for various sources of shore power.

### BACKGROUND

Some vehicles, for example, recreational vehicles, boats, and the like, may be equipped with a mechanism for connecting to shore power from a commercial power system. These vehicles may therefore be arranged such that electrical loads may be powered from shore power or from a battery on the vehicle.

For example, U.S. Pat. No. 6,034,445 to Hewitt discloses a power source transfer lockout circuit. The transfer lockout circuit includes a monitoring circuit connected to each power source, which may require complicated logic and, therefore, increase manufacturing costs. Further, some shore power sources provide 110-120 volts of alternating current (VAC), while others provide 220-240 VAC. The aforementioned transfer lockout circuit does not provide a mechanism for distinguishing the type of shore power input.

The shore power interface of the present invention solves one or more of the problems set forth above.

### SUMMARY OF THE INVENTION

In one aspect, the present invention is directed to power circuit, including a first electrically-energizable contactor configured to receive a first power input of 110-120 VAC, and a second electrically-energizable contactor configured to receive a second power input of 220-240 VAC. The first and second contactors are arranged such that when one of the first and second contactors is energized by the corresponding power input, the energized one of the first and second contactors prevents the other one of the first and second contactors from being energized.

In another aspect, the present invention is directed to a method of operating a power circuit, including selectively supplying a power input to one of a first power input configured to receive 110-120 VAC and a second power input configured to receive 220-240 VAC, and energizing a contactor forming a current flow circuit with the selected one of the first and second power inputs. The energized contactor prevents another contactor associated with the other one of the first and second power inputs from being energized.

### BRIEF DESCRIPTION OF THE DRAWINGS

FIG. 1 is a schematic representation of a shore power interface in accordance with an exemplary embodiment of the present invention; and

FIG. 2 is a diagrammatic side view of an exemplary vehicle including the shore power interface of FIG. 1.

### DETAILED DESCRIPTION

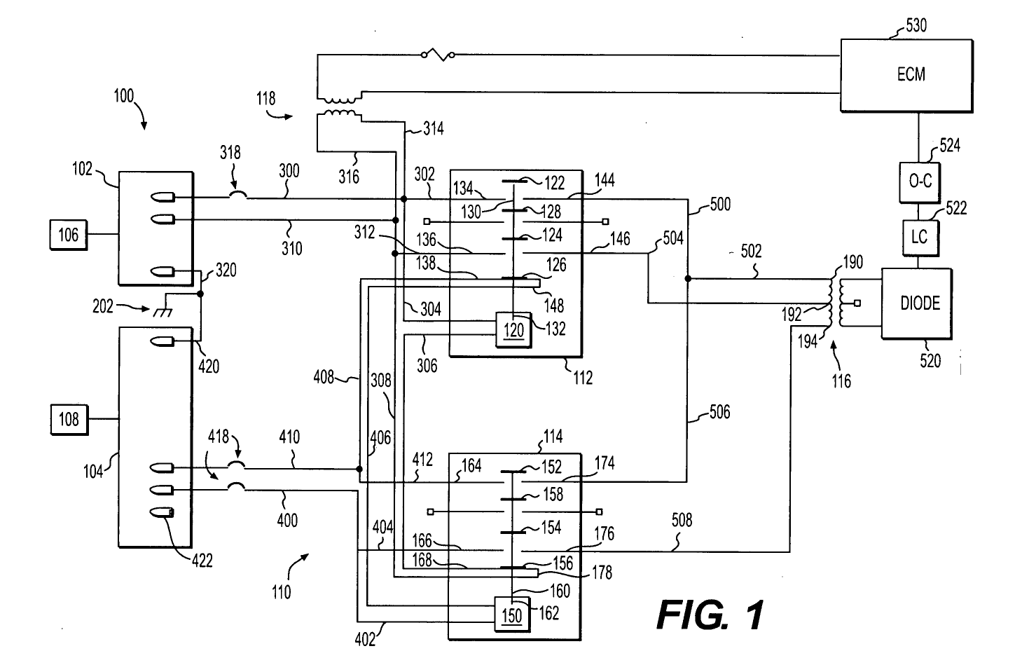

An exemplary embodiment of a shore power interface 100 is illustrated in FIG. 1. The shore power interface 100 may include a first power receptacle 102 and a second power receptacle 104 electrically connected to a power circuit 110. The first power receptacle 102 may receive a utility power input from a first shore power source 106 providing 110-120 VAC. The second power receptacle 104 may receive a utility power input from a second shore power source 108 providing 220-240 VAC. The first power receptacle 102 may be structured, for example, as a standard three-prong receptacle, and the second power receptacle 104 may be structured, for example, as a three-prong twist-lock receptacle.

The power circuit 110 may include a first AC contactor 112, a second AC contactor 114, a power transformer 116, and a signal transformer 118. The first AC contactor 112 may include a coil 120, a first contact 122, a second contact 124, and a third contact 126. The first AC contactor 112 may further include one or more additional contacts 128 for other desired uses. The contacts 122, 124, 126, 128 may be connected to each other via a non-electrically conductive rod 130, for example, a plastic rod, movable relative to the coil 120. The rod 130 may include a magnetic end portion 132 proximate the coil 120. When energized, the coil 120 generates a magnetic field that attracts the end portion 132, thus moving the rod 130 and the contacts 122, 124, 126, 128 toward the coil 120.

The first AC contactor 112 may also include first, second, and third inputs 134, 136, 138, respectively, and corresponding first, second, and third outputs 144, 146, 148, respectively. The corresponding inputs 134, 136, 138 and outputs 144, 146, 148 are connectable to each other via the first, second, and third contacts 122, 124, 126, respectively. As shown in FIG. 1, when the third input 138 and the third output 148 are connected by the normally-closed third contact 126, the first and second inputs 134, 136 are not connected to the first and second outputs 144, 146 by the normally-opened first and second contacts 122, 124.

Similarly, the second AC contactor 114 may include a coil 150, a first contact 152, a second contact 154, and a third contact 156. The second AC contactor 114 may further include one or more additional contacts 158 for other desired uses. The contacts 152, 154, 156, 158 may be connected to each other via a non-electrically conductive rod 160, for example, a plastic rod, movable relative to the coil 150. The rod 160 may include an metallic end portion 162 proximate the coil 150. When energized, the coil 150 generates a magnetic field that attracts the end portion 162, thus moving the rod 160 and the contacts 152, 154, 156, 158 toward the coil 150.

The second AC contactor 114 may also include first, second, and third inputs 164, 166, 168, respectively, and corresponding first, second, and third outputs 174, 176, 178, respectively. The corresponding inputs 164, 166, 168 and outputs 174, 176, 178 are connectable to each other via the first, second, and third contacts 152, 154, 156, respectively. As shown in FIG. 1, when the third input 168 and the third output 178 are connected by the normally-closed third contact 156, the first and second inputs 164, 166 are not connected to the first and second outputs 174, 176 by the normally-opened first and second contacts 152, 154.

The power circuit 110 may include a hot wire 300 from the first power receptacle 102 connected to the coil 120 of the first AC contactor 112 via a wire 302. The hot wire 300 may also be connected to the first input 134 of the first AC contactor 112 via a wire 304. The coil 120 of the first AC contactor 112 may be connected to the third input 168 of the second AC contactor 114 via a wire 306, and a wire 308 may connect the third output 178 of the second AC contactor 114 to a neutral wire 310 of the first power receptacle 102. Another wire 312 may connect the wire 308 with the second input 136 of the first AC contactor 112.

The hot wire 300 of the first power receptacle 102 may be connected to the signal transformer 118 via a wire 314, and another wire 316 may connect the signal transformer 118 to the neutral wire 310 of the first power receptacle 102. The hot wire 300 may include a circuit breaker 318 arranged to prevent damage to the power circuit 110.

The power circuit 110 may also include a first hot wire 400 from the second power receptacle 104 connected to the coil 150 of the second AC contactor 114 via a wire 402. The first hot wire 400 may also be connected to the second input 166 of the second AC contactor 114 via a wire 404. The coil 150 of the second AC contactor 114 may be connected to the third input 138 of the first AC contactor 112 via a wire 406, and a wire 408 may connect the third output 148 of the second AC contactor 114 to a second hot wire 410 of the second power receptacle 104. Another wire 412 may connect the second hot wire to the first input 164 of the second AC contactor 114. Each of the first and second hot wires 400, 410 may include a circuit breaker 418 arranged to prevent damage to the power circuit 110.

The first output 144 of the first AC contactor 112 may be connected to a first end 190 the power transformer 116 via wires 500, 502, and the second output 146 of the first AC contactor 112 may be connected to a center tap 192 of the power transformer 116 via a wire 504. The first output 174 of the second AC contactor 114 may be connected to the first end 190 of the power transformer 116 via wires 506, 502, and the second output 176 of the second AC contactor 114 may be connected to a second end 194 of the power transformer 116 via a wire 508.

The power circuit 110 may include a single phase diode bridge 520 arranged to receive a voltage from the power transformer 116 and to rectify the alternating current to direct current (DC). The diode bridge 520 may feed the voltage to an LC filter 522, which in turn may feed current to an opto-coupler 524. The opto-coupler 524 may be electrically connected to an electronic control module (ECM) 530. The signal transformer 118 may also be connected to the ECM 530 The power circuit 110 may also include a first ground wire 320 associated with the first power receptacle 102 and a second ground wire 420 associated with the second power receptacle 104. The second power receptacle 104 may also include a neutral lead 422.

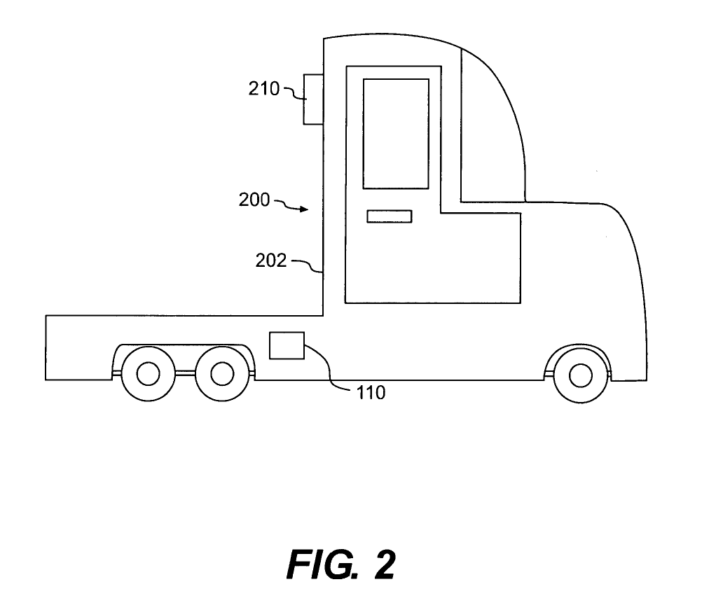

As shown in FIG. 2, the shore power interface 100 may be associated with a vehicle 200, for example a truck, a boat, a recreational vehicle, an automobile, or the like, having a frame 202. The ECM 530 may control power distribution to at least one load 210 associated with the vehicle 200. The at least one load may include an air conditioning unit, a heater, a refrigerator, or the like. The power circuit 110 may also include a first ground wire 320 associated with the first power receptacle 102 and a second ground wire 420 associated with the second power receptacle 104. Referring to FIG. 1, the first and second ground wires 320, 420 may be connected to the frame 202 of the vehicle 200. The second power receptacle 104 may also include a neutral lead 422.

### INDUSTRIAL APPLICABILITY

When the vehicle 200 is stationary, the shore power interface 100 may be connected to a source of shore power 106, 108, where available, to provide utility power to the at least one vehicle load 210 without having to operate the vehicle's engine (not shown).

For example, the shore power interface 100 may be connected to the first shore power source 106 providing 110-120 VAC via the first power receptacle 102. As long as the second power receptacle 104 is not connected to the second shore power source 108, as explained below, a current is fed to the coil 120 of the first AC contactor 112 via hot wire 300 and wire 304. The current energizes the coil 120, causing the rod 130 and associated contacts 122, 124, 126, 128 to move from a first position to a second position in a direction toward the coil 120. In the second position, the normally-closed third contact 126 is opened and the normally-opened first and second contacts 122, 124 are closed. A circuit is then formed that provides a flow of current from the first power receptacle 102 to a first end 190 of the power transformer 116 via hot wire 300, wire 302, first input 134, first contact 122, first output 144, and wires 500, 502, and from the center tap 192 of the power transformer 116 to the first power receptacle 102 via wire 504, second output 146, second contact 124, second input 136, wire 312, and neutral wire 310. With a transformer ratio of 2:1 for voltage between the first end 190 and the center tap 192, the power transformer 116 produces 220-240 VAC for powering the at least one vehicle load 210.

In addition, the opened third contact 126 opens the circuit associated with the second power receptacle 104. Consequently, if the second power receptacle 104 is connected to the second shore power source 108, the coil 150 of the second AC contactor 114 cannot be energized. Thus, the second power receptacle 104 is electrically disabled when the first power receptacle 102 is in use.

Further, when the first power receptacle 102 is connected to the first shore power source 106, current is also supplied to the signal transformer 118. The second transformer transforms the 110-120 VAC to a 12 VAC signal, which may be supplied to the ECM 530. The ECM 530 may be programmed such that when the 12 VAC signal is received, the ECM knows that the utility power input is 110-120 VAC and thus limits the usable power to about 1.5 kilowatts.

Alternatively, the shore power interface 100 may be connected to the second shore power source 108 providing 220-240 VAC via the second power receptacle 104. As long as the first power receptacle 102 is not connected to the first shore power source 106, as explained above, a current is fed to the coil 150 of the second AC contactor 114. The current energizes the coil 150, causing the rod 160 and associated contacts 152, 154, 156, 158 to move from a first position to a second position in a direction toward the coil 150. In the second position, the normally-closed third contact 156 is opened and the normally-opened first and second contacts 152, 154 are closed. A circuit is then formed that provides a flow of current between the hot wires 400, 410 of the second power receptacle 104 via wire 412, first input 164, first contact 152, first output 174, wires 506, 502, the first and second ends 190, 194 of the power transformer 116, wire 508, second output 176, second contact 154, second input 166, and wire 404. With a transformer ratio of 1:1 for voltage between the first and second ends 190, 194, the power transformer 116 produces 220-240 VAC for powering the at least one vehicle load 210.

In addition, the opened third contact 156 opens the circuit associated with the first power receptacle 102. Consequently, if the first power receptacle 102 is connected to the first shore power source 106, the coil 120 of the first AC contactor 112 cannot be energized. Thus, the first power receptacle 102 is electrically disabled when the second power receptacle 104 is in use.

Further, when the second power receptacle 104 is connected to the second shore power source 108, current is not supplied to the signal transformer 118. The ECM 530 may be programmed such that when no 12 VAC signal is received, the ECM knows that the utility power input, if any, is 220-240 VAC and thus does not limit the usable power as with the 110-120 VAC input.

It will be apparent to those skilled in the art that various modifications and variations can be made to the shore power interface of the present invention without departing from the scope of the invention. Other embodiments of the invention will be apparent to those skilled in the art from consideration of the specification and practice of the invention disclosed herein. It is intended that the specification and examples be considered as exemplary only.

What is claimed is:

1. A power circuit, comprising:
a first electrically-energizable contactor configured to receive a first power input of 110-120 volts of alternating current (VAC); and
a second electrically-energizable contactor configured to receive a second power input of 220-240 VAC, the first and second contactors being arranged such that when one of the first and second contactors is energized by the corresponding power input, the energized one of the first and second contactors prevents the other one of the first and second contactors from being energized.

2. The power circuit of claim 1, wherein each of said first and second contactors includes an electrically-energizable coil and a plurality of contacts.

3. The power circuit of claim 2, wherein the coil of the energized one of the first and second contactors generates a magnetic field that moves the plurality of contacts to prevent the other one of the first and second contactors from being energized.

4. The power circuit of claim 3, wherein one of the moved plurality of contacts opens a circuit between the other one of the first and second contactors and the corresponding power input.

5. The power circuit of claim 4, further including a power transformer configured to receive power via the energized one of the first and second contactors and to produce a 220-240 VAC output,
wherein two of the moved plurality of contacts complete a circuit between the energized contactor, the corresponding power input, and the power transformer.

6. The power circuit of claim 1, further including a power transformer configured to receive power via the energized one of the first and second contactors and to produce a 220-240 VAC output.

7. The power circuit of claim 1, further including:
a signal transformer configured to receive power from the first power input when the first contactor is energized and to generate an output signal in response thereto; and
an electronic control module electrically connected to the signal transformer, the electronic control module being configured to determine which of the first and second inputs is providing power to the power circuit based on the output signal of the power transformer.

8. The power circuit of claim 1, further including at least one load, said energized one of the contactors being configured to provide power to the at least one load.

9. A shore power interface, comprising:
the power circuit of claim 1;
a first receptacle configured to receive the first power input from a first power source and to direct current to the first contactor; and
a second receptacle configured to receive the second power input from a second power source and to direct current to the second contactor.

10. A method for operating a power circuit, comprising:
selectively supplying a power input to one of a first power input configured to receive 110-120 volts of alternating current (VAC) and a second power input configured to receive 220-240 VAC; and
energizing a contactor forming a current flow circuit with the selected one of the first and second power inputs, said energized contactor preventing another contactor associated with the other one of the first and second power inputs from being energized.

11. The method of claim 10, wherein said energizing includes energizing a coil of said contactor.

12. The method of claim 11, wherein said energizing generates a magnetic field in the coil that moves a plurality of contacts to prevent said another contactor from being energized.

13. The method of claim 12, wherein one of the moved plurality of contacts opens a circuit between the other one of the first and second contactors and the corresponding power input.

14. The method of claim 13, further including supplying power to a power transformer via said energized contactor and to produce a 220-240 VAC output,
wherein two of the moved plurality of contacts complete a circuit between said energized contactor, the selected power input, and the power transformer.

15. The method of claim 10, further including supplying power to a power transformer via said energized contactor and to produce a 220-240 VAC output.

16. The method of claim 1, further including:
supplying power to a signal transformer from the first power input when a contactor associated with the first power input is energized;
generating an output signal is response to the supplied power; and
determining which of the first and second power inputs is providing power to the power circuit based on the output signal of the signal transformer.

17. The method of claim 10, further including providing power to at least one load via said energized contactor.

18. A shore power interface for a vehicle, including:
a first receptacle configured to receive a first power input from a first power source of 110-120 volts of alternating current (VAC); and
a second receptacle configured to receive a second power input from a second power source of 220-240 VAC;
a first electrically-energizable contactor configured to receive the first power input; and
a second electrically-energizable contactor configured to receive the second power input, the first and second contactors being arranged such that when one of the first and second contactors is energized by the corresponding power input, the energized one of the first and second contactors prevents the other one of the first and second contactors from being energized.

19. A vehicle, comprising:
the shore power interface of claim 18; and
at least one electrical load associated with the vehicle, the shore power interface being configured to power the at least one electrical load.

20. The vehicle of claim 19, wherein the vehicle is one of a truck, a boat, and a recreational vehicle.
